(19) United States
(12) Patent Application Publication
(10) Pub. No.: US 2010/0141654 A1
(43) Pub. Date: Jun. 10, 2010

(54) Device and Method for Displaying Feature Marks Related to Features in Three Dimensional Images on Review Stations

(76) Inventors: Huzefa F. Neemuchwala, Sunnyvale, CA (US); Ashwini Kshirsagar, Cupertino, CA (US)

Correspondence Address: CYTYC CORPORATION;Darry Pattinson, Sr. IP Paralegal, 250 CAMPUS DRIVE, MARLBOROUGH, MA, 01752, US

(21) Appl. No.: 12/330,176

(22) Filed: Dec. 8, 2008

(51) Int. Cl. G06T 15/20

(52) U.S. Cl. 345/427

(57) ABSTRACT

A system is provided for displaying information associated with at least one feature of a three-dimensional image. The three-dimensional image is apportioned along a plane into a plurality of 2-D image slices and a display is provided for viewing the 2-D image slices. A feature window of the present invention is positioned together with a 2-D image display. The feature window displays feature distribution along a plane normal to the plane of the 2-D image slices for one or more regions of interest, thereby increasing reviewing efficiency by enabling visualization of three-dimensions of information using a 2 dimensional display. As a result a reviewer is able to quickly identify image slices with the most pertinent feature information and diagnostic efficiency and accuracy is greatly increased.

### FIELD

This patent specification relates generally to the field of medical imaging and more particularly to a device and method for displaying information associated with one or more features of a three dimensional medical image.

### BACKGROUND

Progress toward all-digital medical imaging environments has substantially increased the speed at which large amounts of medical image information can be accessed and displayed to a radiologist. X-ray based imaging for breast cancer screening/diagnosis is a particularly important field that is experiencing such information-expanding technological progress. Historically breast cancer screening/diagnosis has used conventional mammography techniques, where an x-ray source projects x-rays through a breast that is immobilized by compression against a breast platform. A two-dimensional projection image of the breast, referred to as a mammogram, is captured by a film or digital detector located beneath the breast platform.

Although conventional x-ray mammography is currently recognized as one of the best FDA approved method for detecting early forms of breast cancer, it is still possible for cancers to be missed during radiological viewing of the mammogram. A variety of factors, such as breast density, may contribute to the failure to detect breast cancers.

For these and other reasons, substantial attention and technological development has been dedicated towards obtaining a three-dimensional image of the breast, using methods such as breast computed tomography (CT) and breast tomosynthesis. Both breast CT and breast tomosynthesis are three-dimensional imaging technologies that involve acquiring images of a stationary compressed breast at multiple angles during a short scan. Each individual image is referred to herein as a 2-D projection image. The individual 2-D projection images are then reconstructed into a 3-D volume comprising a series of thin high-resolution slices that can be displayed individually or in a dynamic cine mode. One critical different between breast CT and breast tomosynthesis is the number of images that are obtained; where a breast CT scan will acquire images around a full circumference of the image (i.e., along a 360 degree span), the tomosynthesis images are taken at a limited angular span.

Reconstructed tomosynthesis slices reduce or eliminate the problems caused by tissue overlap and structure noise in single slice two-dimensional mammography imaging. However, in progressing from conventional x-ray mammography to tomosynthesis or CT imaging, practical issues arise with regard to the rising volume of data that is required to be reviewed by a radiologist. Whereas there are usually just four conventional x-ray mammogram images per patient, there can be hundreds of CT or tomosynthesis reconstructed image slices. As more visual information becomes available, an important challenge is to present such information to the radiologist effectively and efficiently such that screening for abnormalities can be done thoroughly and effectively and yet in a reasonable time to be practical.

Of particular importance is the manner in which an image review workstation displays Computer Aided Detection (CAD) markers to the radiologist in the large stack of tomosynthesis reconstructed images. While it is desirable that the CAD markers not be overly obtrusive on their corresponding image, it is also desirable that they not be readily overlooked as the radiologist moves through his/her examination of the image slices. One problem that may be encountered when reviewing CAD markers in a tomosynthesis data set is that the markers are not located on all of the image slices; in fact, in a given set it may be that CAD markers are only located on a few of the images. One method of facilitating a more reliable CAD review during a radiological reading is described in U.S. patent application Ser. No. 11/903,021, filed Sep. 20, 2007 and entitled “Breast Tomosynthesis with Display of Highlighted Suspected Calcifications,” filed by the present assignee. As shown in FIG. 4 of that application, a ruler identifying the slices is provided for display. Each slice that contains a marker has an indicator positioned next to the ruler. With such an arrangement a reviewer can reduce the number of images that are examined, thereby increasing reviewing efficiency.

Another method of facilitating a more reliable CAD review during radiological reading is described in U.S. patent application Ser. No. 11/906,566 filed Oct. 2, 2007 and entitled ‘Displaying Breast Tomosynthesis Computer-Aided Detection Results.’ As described in that application, a CAD proximity marker is included on an image slice which is near another slice that includes a CAD marker. Both of the above techniques also reduce the chance that an image slice will overlooked during review, yet each still require sifting through multiple images to identify those images with the most relevant information.

### SUMMARY

According to one aspect of the invention, it is realized that in reviewing a large data set it is desirable to have CAD information accessible such that it can be assimilated readily by the radiologist. CAD marker accessibility can be improved by providing the radiologist with an overview of marker position, size, type or other CAD marker related information within the slice under review, even though the information itself extends in many slices.

According to one aspect of the invention, a system is provided for displaying information associated with at least one feature of a three-dimensional image. The three-dimensional image is apportioned along a plane into a plurality of 2-D image slices and a display is provided for viewing the 2-D image slices. A feature window of the present invention is positioned together with a 2-D image display. The feature window displays feature distribution along a plane normal to the plane of the 2-D image slices for one or more regions of interest, thereby increasing reviewing efficiency by enabling visualization of three-dimensions of information using a 2 dimensional display. As a result a reviewer is able to quickly identify image slices with the most pertinent feature information and diagnostic efficiency and accuracy is greatly increased.

According to one aspect of the invention, the system of the present invention includes a process of locating a plurality of features in the plurality of image slices and apportioning the located plurality of features into one or more groups of features having a shared attribute. The process generates a feature window which comprises an identifier portion comprising identifiers for each of the groups of features and a graph portion. The graph portion comprises a plurality of rows associated with the plurality of image slices and a plurality of columns associated with features. According to one aspect of the invention the identifiers for each of the groups are arranged such that the selection of a group identifier results in a display, in the graph portion of the feature window, of the quantity of features that are associated with the group identifier and that are in each image slice. Thus the feature window enables a reviewer to visually determine a feature depth and/or feature expanse of a region of interest.

According to one aspect of the invention, a 2-D image slice is displayed with the feature window. In one embodiment, an initial 2-D image slice is selected for display in response to the selection of a group identifier, where the selected 2-D image slice is selected based on a relationship between the selected slice and the feature information associated with the group identifier. For example, a 2-D image may be selected because it is in a slice at the center of the region of interest associated with the group identifier. Alternatively, a slice may be selected because it has the highest number of features in the group. Other methods of pre-selecting an image slice may be substituted herein. Such an arrangement increases diagnostic efficiency by directing a reviewer to 2-D image slices based on 3-D CAD marker information.

According to a further aspect of the invention, the feature window includes a scroll bar having a length related to a number of 2-D slices in the 3-D image data. A marker on the scroll bar provides a visual indication of which 2-D image slice is currently on display. In one embodiment movement of the scroll bar (using for example a mouse, touch screen or other similar user interface) changes the 2-D image that is on display. In one embodiment, should a user move between slices that are associated with different group identifiers, the feature window is updated such that only feature information that is relevant to the viewed slice is displayed in the feature window.

These and other features of the present invention will now be described in conjunction with the below figures, where like numbers refer to like elements in the different drawings.

### BRIEF DESCRIPTION OF THE FIGURES

FIG. 1 is a block diagram including illustrative components of a system of the present invention;

FIGS. 2A and 2B are diagrams illustrating contents of the feature window of the present invention, including feature information for two different groups of interest;

FIGS. 3A and 38 are diagrams illustrating different embodiments of a feature window of the present invention;

FIG. 4 is a snapshot of a display screen which includes a feature window as described with regards to FIGS. 2A and 2B; and

FIG. 5 is a flow diagram provided to illustrate exemplary steps that may be performed to generate and display a feature window of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Although the following description refers to the use of a feature window of the present invention to facilitate review of breast tomosynthesis data it will readily be appreciated by one of skill in the art that the concepts of the invention may be extended for use in viewing information available in any dimension of a three-dimensional data set provided by any means. Thus the below description should be viewed only as illustrative and not limiting. Although certain terms and definitions will be provided which have particular relevance to breast imaging it will be appreciated that equivalent elements are found in the related arts. For example, although mention may be made to mammograms and tomosynthesis projection images, such images should be viewed as equivalents to any 2-D image as a part of a three dimensional volume.

That said, the following abbreviations shall have the following definitions throughout this application. The notation Mp refers to a conventional mammogram, which is a two-dimensional projection image of a breast and encompasses both a digital image as acquired by a flat panel detector or another imaging device and the image after conventional processing to prepare it for display to a health professional or for storage, e.g. in the Picture ArChiving System (PACS) of a hospital or another institution. Tp refers to an image that is similarly two-dimensional but is taken at a respective tomosynthesis angle between the breast and the origin of the imaging X-rays (typically the focal spot of an X-ray tube), and also encompasses the image as acquired as well as the image after being processed for display or for some other use. Tr refers to an image that is reconstructed from images Tp, for example in the manner described in said earlier-filed patent applications, and represents a slice of the breast as it would appear in a projection X-ray image of that slice at any desired angle, not only at an angle used for Tp or Mp images.

The terms Tp, Tr, and Mp also encompasses information, in whatever form, that is sufficient to describe such an image for display, further processing, or storage. The images Mp, Tp and Tr typically are in digital form before being displayed, and are defined by information identifying properties of each pixel in a two-dimensional array of pixels. The pixel values typically relate to respective measured or estimated or computed responses to X-rays of corresponding volumes in the breast (voxels or columns of tissue).

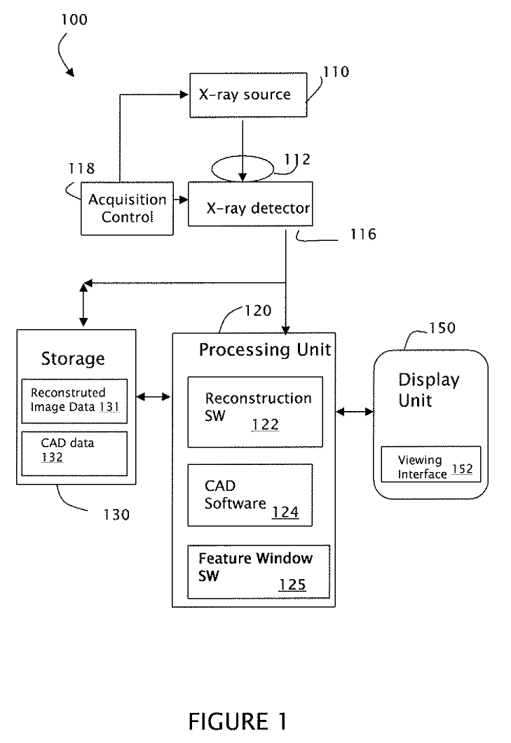

FIG. 1 illustrates a three dimensional imaging system in which the present invention may advantageously be used. Although FIG. 1 illustrates components of a tomosynthesis system, as mentioned above the present invention is not limited to use with any particular system, but may also be beneficially used in computed tomography (CT) systems, combination mammography/tomosynthesis systems, or any system which uses Computer Aided Detection (CAD) software tools in conjunction with multi-dimensional image data. Generally speaking, the present invention may be used in any system which has obtained a 3 dimensional volume set.

FIG. 1 illustrates, in block diagram, form an x-ray data acquisition unit 100 that includes an x-ray source 110 imaging a breast 112. An x-ray imager 116 such as a flat panel x-ray imager commercially available from the assignee of this patent specification generates projection image data that can be a mammogram Mp or a tomosynthesis projection image Tp. X-ray source 110 is mounted for movement so that images Tp can be taken at different angles. X-ray imager 116 can be stationary or it can also move, preferably in synchronism with movement of x-ray source 110. Elements 110 and 116 communicate with x-ray data acquisition control 118 that controls operations in a manner known from said earlier-filed patent specifications. X-ray image data from imager 116 is delivered to processing unit 120. Processing unit 120 comprises reconstruction software 122, which may be stored in a computer readable medium of unit 12. The reconstruction software processes x-ray image data into Tp and Tr image data, which may be stored in storage device 130 as reconstructed data 131 and displayed at image display unit 150 as disclosed in the various embodiments described above. Processing unit 120 further includes 2D CAD software 124 which processes the Tp and/or Tr data. CAD systems are used to assist radiologists in the interpretation of millions of mammograms per year. X-ray mammography CAD systems are described, for example, in U.S. Pat. No. 5,729,620, U.S. Pat. No. 5,815,591, U.S. Pat. No. 6,014,452, U.S. Pat. No. 6,075,879, U.S. Pat. No. 6,301,378 and U.S. Pat. No. 6,5764,357, each of which is incorporated by reference herein. Application of CAD algorithms to one or more of tomosynthesis projection images and tomosynthesis reconstructed images has been proposed in U.S. Pat. No. 6,748,044 and U.S. Pat. No. 7,218,766, each of which is incorporated by reference herein.

CAD software 124 retrieves the 3-D reconstructed data 131 from storage 130 and processes the tomosynthesis data set, generating CAD overlay images for display over each of the 2-D image slice. A CAD overlay image may include one or more markers which are associated with features of a corresponding image slice that are suggestive of a cancerous or pre-cancerous lesions. The CAD overlay images are referred to herein as the CAD data set 132 and following generation may be stored in the storage device 130 along with the reconstructed data.

Feature window software 125 is, in one embodiment, a software module which can be loaded on any system that stores 3-D image data for display. The software module is stored in a computer readable medium of the system, and operable when executed upon by a processor of the system to generate an initial display which introduces the 3-D data set to a radiologist in a manner that facilitates review of the data set. The Feature Window software 125 includes functionality for identifying features that correspond to a common region of interest, grouping the identified features, assigning an a group identifier to the related features, identifying an initial 2-D image slice for display when viewing each group, and populating a feature window data structure with feature information for the 3-D data set. The identified initial 2-D image for each group may be that 2-D image of the group which has the most features, or which is centered within the image slices of the group.

The feature window software may also advantageously select an introductory 2-D image slice and feature group for introductory presentation of the 3-D data set to the radiologist. For example, the introductory 2-D image may be associated with the group having the largest number of features, or the 2-D image having the most features.

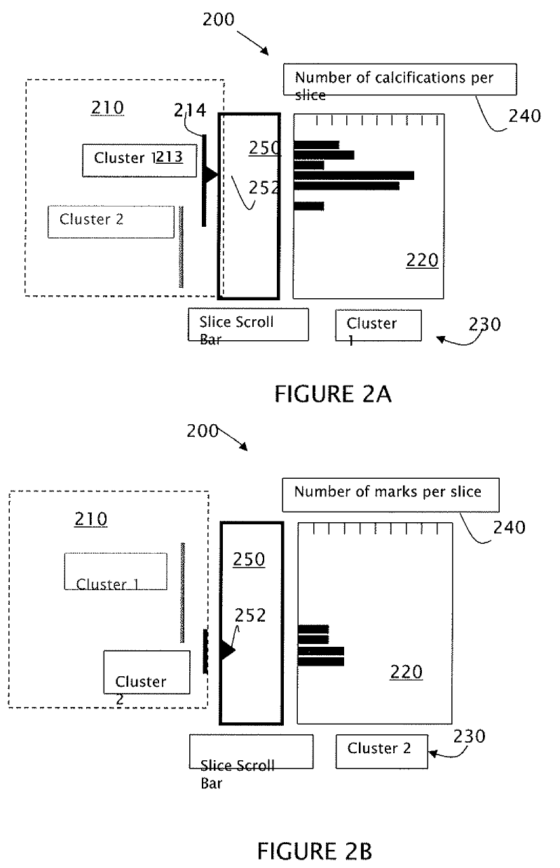

FIGS. 2A and 2B illustrate exemplary information that may be included in a feature window 200 of the present invention. For the purpose of this application a feature window shall be defined to comprise a portion of a visualizer which displays data associated with features of the 3-D image. In FIG. 2A feature window 200 is shown to include a group identifier portion 210, a graph portion 220, a dynamic legend 230, a label 240 and a scroll bar 250. The group identifier portion 210 includes one or more selectable icons 211, 212. The selectable icons include a group identifier and 213 and an expanse bar 214. The selectable icon may be selected in any manner that is currently available to select a displayed icon, including but not limited to the use of a mouse, touch screen or the like. In addition, the icon itself may not be selectable, but may be tied to a different pull down menu or other device at another interface to the system. The group identifier 213 is a label identifying the group, while the expanse bar 214 visually indicates the number of images which include features associated with the group identifier. For example, in a system that uses 2-D images slices which are parallel to the plane of an imaging detector, the expanse bar 214 indicates the number of slices that are normal to the plane of the image detector and which are associated with a group feature; thus providing a visual cue as to the depth of the feature.

The graph portion 220 provides quantative feature information; the graph pictorially represents the number of features per image slice for one or more selected group(s). In one embodiment feature information associated with only one group is shown at any given time. In such an embodiment, as shown in FIG. 2A, the illustrated group identifier is represented in a highlighted or bolded font. A dynamic legend 230 is populated with label of the selected group identifier, to more clearly convey the source of feature information to a reviewer of the image data. The graph portion 220 is populated with feature information for the selected group. One form of presenting the information is shown in FIG. 2A as a histogram of the number of features (calcifications in this example) identified for each of the slices. Other embodiments are also envisioned, for example where multiple feature groups are simultaneously graphed, each group having a visually distinct font, color or symbol.

Also shown in the feature window 200 is scroll bar 250. In one embodiment the scroll bar 250 is a manipulable interface that can be used to control the selection of an image slice on a display. A marker on the scroll bar, such as watermark 252, provides a visual indication of which slice is currently displayed on a visualizer. A reviewer can move up and down the stack of 2-D image slices using the scroll bar, for example via a mouse interface, touch screen or the like, to display different slices of the 3-D image data.

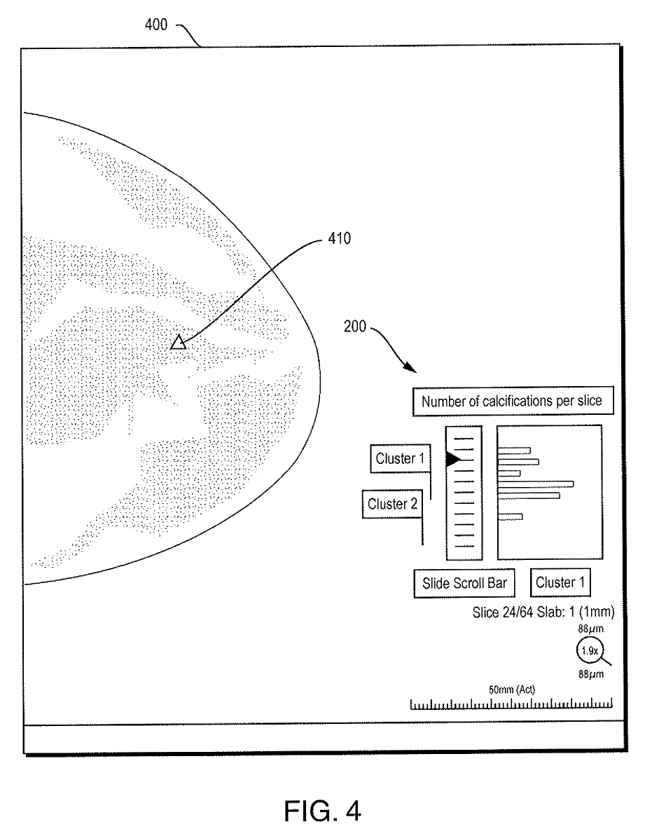

As mentioned above, according to one aspect of the invention, when a group identifier is selected the graph portion of the feature window is automatically populated with feature information for the group. The feature window may be displayed proximate to a 2-D image slice related to the feature group. For example, as shown in FIG. 4, a 2-D slice image may be displayed on the display device together with feature window 200, where the initial 2-D image is a preselected image for that group identifier. The 2-D image may be preselected using any criteria. For example, it may be desirable to display the 2-D image associated with the slice in the group with the largest number of features. Alternatively, it may be desirable to display the median slice, i.e., the slice associated with the median feature of the group. Others may determine it desirable to start with the top image slice, or the bottom image slice. It is envisioned that different reviewers may have different styles of proceeding through a feature set, and thus it may be desirable to provide an interface that allows the reviewer to select how an initial image for each feature set will be selected, from a predetermined set of selection methods.

Referring back to FIG. 2A, the graph portion 220 may be used to intelligently guide the reviewer's examination of the 2-D slice images. Because the graph shows the number of features in each slice, the reviewer can ensure that review time is used efficiently by examining those slices with the highest amount of feature data. Diagnostic accuracy is also increased with the use of the feature window, as the chances of missing an image slice with feature data are minimized.

When a reviewer has completed examination of images slices related to one region of interest, the reviewer may easily switch to a next region of interest by simply selecting the group identifier associated with that region. Once the next group identifier is selected, in one embodiment only the feature information associated with that group identifier are displayed in the graph portion 220 of the feature window. FIG. 2B illustrates how the contents of graph portion 220 are modified when “cluster 2” is selected; only feature data for the group identifier is displayed, and the dynamic legend 230 is updated to reflect the contents of the graph 220.

For the purposes of this application, ‘feature’ information shall include any detectable quality of the 2-D image. These qualities include, without limitation, CAD marks indicative of bright areas which may indicate calcifications or patterns within the areas that may indicate lesions. Other features which can be represented in the display window include the breast composition (including percentage or number of pixels in the slice identified to belong to breast fat or the mammary gland (also commonly referred to as dense tissue)) or any other features known or identified in the future. Accordingly the present invention is not limited to the display of any particular type of feature.

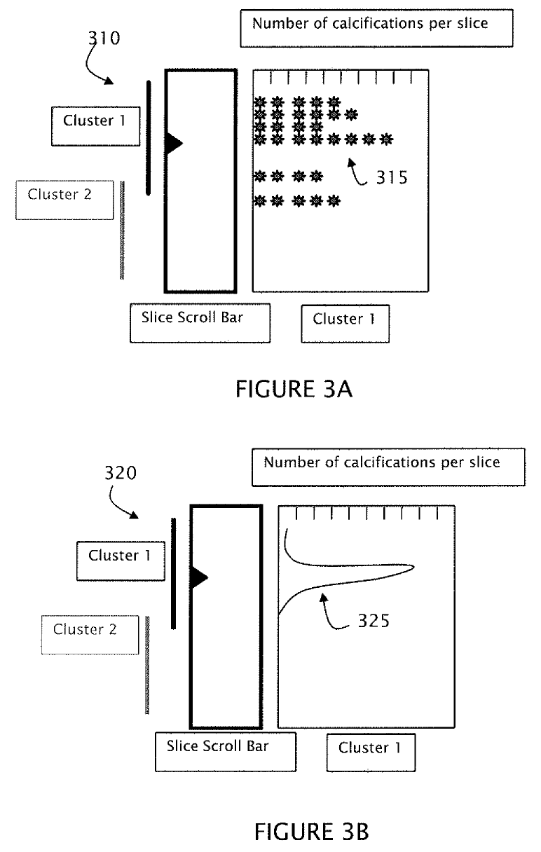

FIGS. 3A and 3B illustrate additional embodiments of the feature window of the present invention. In FIG. 3A, rather than a bar graph as shown in FIG. 2, the histogram is represented using symbols. In other embodiments, for images that have different types of CAD symbols, (i.e., to indicate different types of calcifications or lesions) it is envisioned that the graph itself may include different symbols to represent the feature data. FIG. 3B shows the feature information in extrapolated graph form.

Referring again to FIG. 4, the feature window 200 is shown displayed as part of the 2-D image slice. Such an arrangement enables the reviewer incorporate information from the third dimension (i.e., from neighboring slices) into their considerations regarding the viewed slice without the need to move between separate display screens. While such an arrangement is preferable for purposes of efficiency, it is not a requirement of the invention and alternate embodiments where the feature window is provided at other locations in the display, or at other interfaces that are viewable by the reviewer, are considered equivalents to the present invention.

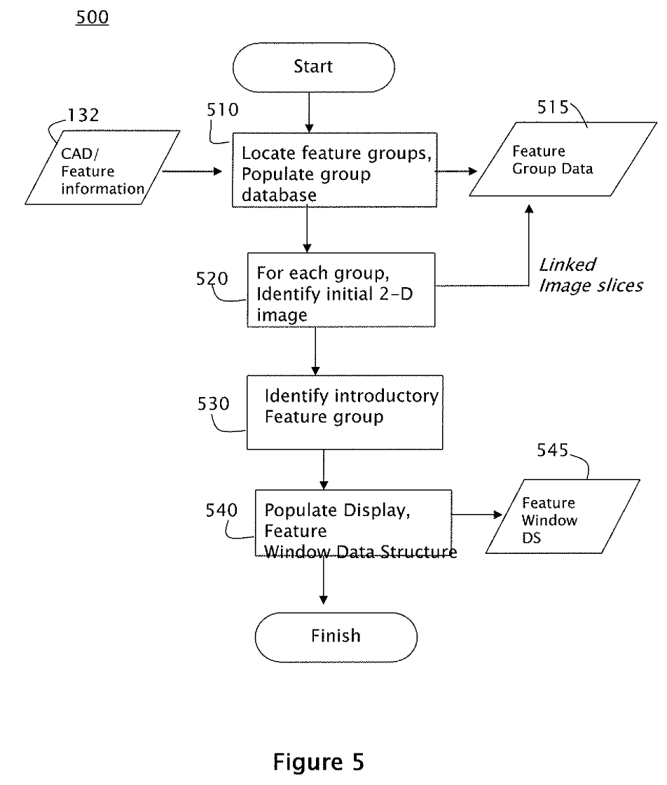

FIG. 5 is a flow diagram provided to illustrate exemplary steps that may be performed in a process 500 of the present invention for populating a feature window. At step 510 the process analyzes CAD/feature information, apportioning the feature information into groups based on some pre-determined criteria. For example, assuming the feature is a CAD mark, CAD marks having a given proximity (in any dimension) to each other could be identified as belonging to a particular ‘group’. The degree of proximity may vary depending upon the type of CAD mark or other criteria. Other mechanisms for identifying the group may also be used, using heuristics and pattern recognition techniques known to those of skill in the art. In an example where the feature is breast density, each 2-D image may be segmented and a percentage or number of pixels in the image identified to belong to breast fat or the mammary gland (also commonly referred to as dense tissue) may be made.

Once groups of features have been identified, the groups are recorded in a feature group data structure 515. The feature group data structure may take any one of many forms using software programming techniques such as object oriented programming, linked list or the like. In general, each feature group will include a group identifier that is associated with a list of image slices and a count of features in each image slice. At step 520, each feature group is evaluated to identify a 2-D image slice for initial display with the group. As mentioned above the criteria for selection of an initial 2-D image may vary depending upon reviewer preference. Once the initial 2-D image slice is selected, it is linked to the appropriate group, for example by updating a field or attribute in the group data structure.

At step 530 an introductory feature group is selected. The introductory feature group comprises a feature group (and associated 2-D image) selected from all available feature groups based on a predetermined criteria. For example, the introductory feature group may correspond to that group having the largest number of features, or that group which spans the most 2-D image slices, or some other criteria.

At step 540 the feature window data structure 545 is populated with the group identifiers. The graph portion of the data structure is linked to the feature information from the introductory feature group, while the dynamic legend and fonts of the feature window are updated to reflect selection of the introductory feature group. The process of preparing the data for display is then complete.

The process 500 may be performed upon the selection of a case for review by a radiologist. Alternatively, the process may be run in the background prior to selection of any particular case by the radiologist. Whenever the feature window data structure is populated, once it is populated it may be used by the radiologist to quickly parse through large data volumes to identify those image slices of interest.

Accordingly a system and method has been shown and described that enables three-dimensional feature information to be displayed to a radiologist using a two dimensional display. Having described exemplary embodiments, it can be appreciated that the examples described above are only illustrative and that other examples also are encompassed within the scope of the appended claims. Elements of the system and method are embodied in software; the software modules of the present invention have been described to be stored in a computer readable medium and operable when executed upon by a computer processing machine to transform information from 2-D slice images into a displayable representation of the third dimension of the feature. Several advantages are gained by this transformation; for example, the time needed to review large sets of image data to detect potential cancerous lesions can be reduced and the accuracy with which a large image data set is reviewed is increased. As such, the present invention fills a critical need in the art to ensure that diagnostic screening is performed with efficiency and accuracy.

It should also be clear that, as noted above, techniques from known image processing and display methods such as post-production of TV images and picture manipulation by software such as Photoshop from Adobe, can be used to implement details of the processes described above. The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A system for displaying information associated with at least one feature of a three-dimensional (3D) image comprises:
a two-dimensional (2D) display device for viewing information associated with the 3D image, wherein the 3D image is apportioned along a first plane into a plurality of 2-D image slices and at least one 2D image is displayed on the display device; and
a feature window for displaying a distribution of at least one feature group in a second plane normal to the first plane.

2. The system of claim 1 wherein the at least one 2D image displayed on the display device is associated with the feature group.

3. The system of claim 1 wherein the feature window is displayed on the same device as the 2D image.

3. The system of claim 3 wherein the feature window is displayed within the 2D image.

4. The system of claim 1 wherein the feature window comprises a group identifier portion and a graph portion, and wherein the group identifier portion identifies a feature group and the graph portion displays a feature group distribution.

5. The system of claim 4 wherein the group identifier portion identifies a plurality of selectable feature groups, and the graph portion displays the feature group distribution for a selected feature group.

6. The system of claim 4 wherein the group identifier portion identifies a plurality of feature groups, and the graph portion displays the feature group distribution for at least a subset of the feature groups.

7. The system of claim 6, wherein feature group distributions are represented differently for each of the feature groups.

8. The system of claim 1 wherein the feature window comprises a visual representation of a feature window data structure stored in a computer readable medium of the system.

9. The system of claim 8 wherein the graph portion represents the distribution of features using a histogram.

10. The system of claim 8 wherein the graph portion represents the distribution of features using a chart.

11. The system of claim 8 wherein the graph portion represents the distribution of features using an extrapolated curve.

12. The system of claim 1 wherein the feature is associated with a composition of an imaged body part.

13. The system of claim 12 wherein the feature is related to calcification of the imaged body part.

14. The system of claim 12 wherein the feature is a related to lesions in the imaged body part.

15. The system of claim 12 wherein the feature is related to a degree of fat in the imaged body part.

16. A method for displaying three-dimensional (3D) feature information from a three-dimensional (3D) image on a two-dimensional display device includes the steps of:
locating a plurality of features in the plurality of 2D image slices of the 3D image and apportioning the located plurality of features into one or more feature groups, each feature having a shared attribute;
populating a feature group data structure for each of the one or more feature groups with:
a feature group identifier, a list of 2D image slices which include at least one feature having the shared attribute, and a feature group count, for each of the 2D image slices in the list, of features having the shared attribute;
populating a feature window data structure comprising a group identifier portion and a graph portion, wherein the group identifier portion is populated with the feature group identifiers and the graph portion is populated using the feature group counts; and
displaying the feature window data structure together with at least one 2D image slice on the 2D display to thereby enable visualization of three-dimensions of feature information on the 2D display.

17. The method of claim 16 further wherein the at least one 2D image slice displayed on the 2D display is related to at least one feature count in the graph portion of the feature window.

18. The method of claim 16 including the step of, for each of the one or more feature groups, selecting a 2D image from the list of 2D images of the feature group as an initial image for display when the feature group identifier for the group is selected.

19. The method of claim 18 wherein the step of selecting the 2D image from the list of 2D images includes the step of identifying a highest feature 2D image having the largest feature count.

20. The method of claim 18 wherein the step of selecting the 2D image from the list of 2D images includes the step of identifying a median 2D image associated with a median feature count.

21. The method of claim 18 wherein the step of selecting the 2D image from the list of 2D images includes the step of identifying a first 2D image slice of the group.

22. The method of claim 18 wherein the step of selecting the 2D image from the list of 2D images includes the step of identifying a last 2D image slice of the group.

23. The method of claim 16 including the step of selecting an introductory feature group, and displaying a 2D image and feature information associated with the introductory feature group.

24. The method of claim 23 wherein the introductory feature group is selected by selecting the feature group having the highest feature count.

25. The method of claim 16 wherein the introductory feature group is selected by selecting the feature group having a 2D image slice with the highest feature count.

26. The system of claim 25 wherein the feature is associated with a composition of an imaged body part.

27. The system of claim 25 wherein the feature is related to calcification of the imaged body part.

28. The system of claim 25 wherein the feature is a related to lesions in the imaged body part.

29. The system of claim 25 wherein the feature is related to a degree of fat in the imaged body part.
